(19) United States
(12) Patent Application Publication
(10) Pub. No.: US 2012/0068887 A1
(43) Pub. Date: Mar. 22, 2012

(54) Multi-Frequency Antenna

(75) Inventors: Tsung-Wen Chiu, Taipei County (TW); Fu-Ren Hsiao, Taipei County (TW); Yao-Yuan Chang, Taipei County (TW); Kuo-Chan Fu, Taipei County (TW)

(73) Assignee: ADVANCED CONNECTEK INC., Taipei County (TW)

(21) Appl. No.: 13/025,000

(22) Filed: Feb. 10, 2011

(30) Foreign Application Priority Data
Sep. 17, 2010 (TW) 099131559

(51) Int. Cl. H01G 5/01; H01Q 1/36

(52) U.S. Cl. 343/700 MS

(57) ABSTRACT

A multi-frequency antenna comprises a first conductor, a second conductor, a feeder conductor, a short-circuit member, a grounding plane and a feeder cable. The first conductor has a serpentine form. The second conductor is parallel to the first conductor and extends in one side of the first conductor. The feeder conductor connects the first conductor and the second conductor. The short-circuit member connects with the second conductor and extends serpentinely with an end thereof connecting with the grounding plane. The short-circuit member is arranged in one side of the second conductor and connects with the second conductor at a near-central point of the second conductor, which divides the second conductor into a first extension and a second extension. The feeder cable includes a central wire connecting with the feeder conductor and an external wire connecting with the grounding plane.

### BACKGROUND OF THE INVENTION

1. Field of the Invention

The present invention relates to an antenna, particularly to a multi-frequency antenna, which integrates several operating frequency bands in an antenna system.

2. Description of the Related Art

With fast progress of wireless communication technology, RF channels become more and more crowded. Wireless communication technology has expanded from dual-band systems to triple-band or even quad-band systems. In 2007, the industry of notebook computer's antenna has a bigger change: The wireless communication begins to enter the 3G or 3.5G age after the Centrino chip had pushed maturation of built-in WLAN. Thus, the number of the built-in antennae also increases. The current notebook computers are mainly equipped with built-in antennae. In the Centrino age, there are only two built-in antennae. In the 3G age, there may be 5-6 built-in antennae. The additional antennae include an 802.11n MIMO antenna, two 3G antennae, and even one or two UWB antennae.

After notebook computers joined the mobile communication industry, the manufacturers have to propose a sophisticated antenna design and a superior RF system implementation tactic, in addition to a standard 3G communication module, so that the notebook computers can transceive signals accurately and noiselessly in a communication environment full of interference. Further, a notebook computer involves many communication systems, such as GPS, BT, Wi-Fi, WiMax, 3G/LTE and DTV. How to achieve an optimized design compatible to these wireless communication systems has been a critical technology in the field. The customers have a very high requirement for the compactness and slimness of notebook computers. How to integrate more and more antenna modules into smaller and smaller space without mutual interference becomes a big challenge for designers.

### SUMMARY OF THE INVENTION

One objective of the present invention is to provide a multi-frequency antenna, wherein a feeder conductor, a second conductor and a short-circuit member form a dual-band antenna structure, and wherein the feeder conductor, a first conductor and the short-circuit member form a single-band loop antenna structure, and wherein the junction of the short-circuit member of the first conductor and the second conductor is in an open-loop state to prevent from mutual interference of the antenna structures, whereby several antenna modules are integrated in an identical structure, and whereby is increased the operating frequency bands and miniaturized the antenna system.

Another objective of the present invention is to provide a multi-frequency antenna, wherein a first conductor and a short-circuit member form a single-band loop antenna structure, and wherein the first conductor excites a first resonant mode, and wherein the length of an end of the short-circuit member to a feeder point of a central wire is equal to one fourth of the wavelength of the first resonant mode, and wherein the end of the short-circuit member is in a short-circuit state, and wherein the feeder point of the feeder member, which is connected with the end of the short-circuit member via an one-fourth wavelength long path, is in an open-loop state, wherein when the central frequency of the first resonant mode has one-fourth wavelength, the high-frequency and low-frequency resonant modes generated by the second conductor would not interfere with the performance of the first conductor.

To achieve the abovementioned objectives, the present invention proposes a multi-frequency antenna, which comprises a first conductor, a second conductor, a feeder conductor, a short-circuit member, a grounding plane and a feeder cable. The first conductor has a serpentine form. The second conductor is parallel to the first conductor and extends in one side of the first conductor. The feeder conductor connects the first conductor and the second conductor. The short-circuit member connects with the second conductor and extends serpentinely with an end thereof connecting with the grounding plane. The short-circuit member is arranged in one side of the second conductor and connects with the second conductor at a near-central point of the second conductor, which divides the second conductor into a first extension and a second extension. The feeder cable includes a central wire connecting with the feeder conductor and an external wire connecting with the grounding plane.

The present invention proposes an antenna structure integrating several antennae respectively transceiving signals at different frequencies, wherein a feeder conductor, a second conductor and a short-circuit member jointly form an antenna structure. The short-circuit member connects with the second conductor at a near-central point of the second conductor, which divides the second conductor into a first extension and a second extension, whereby are generated a high-frequency resonant mode and a low-frequency resonant mode, and whereby is achieved a dual-band antenna structure.

In the present invention, the junction of the second conductor and the short-circuit member of the first conductor is designed to be in an open-loop state to prevent from mutual interference of the signals of the two antennae, whereby two antenna modules are integrated in an identical radiation conductor structure with antenna miniaturization achieved simultaneously.

In the present invention, the length, size and volume of the short-circuit member are fine-tuned to make the system bandwidth of the antenna have better impedance matching. Further, the length, size and shape of the serpentine path of the first conductor are also fine-tuned to make the system bandwidth of the antenna have superior impedance matching. Below, the embodiments are described in detail to further demonstrate the technical contents of the present invention.

### BRIEF DESCRIPTION OF THE DRAWINGS

FIG. 1 is a top view of a multi-frequency antenna according to a first embodiment of the present invention;

FIG. 2 is a top view of a multi-frequency antenna according to a second embodiment of the present invention;

FIG. 3 is a diagram showing the VSWR measurement results of the multi-frequency antenna according to the second embodiment of the present invention; and

FIG. 4 is a partially-enlarged perspective view schematically showing that the multi-frequency antenna of the second embodiment of the present invention is applied to a portable computer.

### DETAILED DESCRIPTION OF THE INVENTION

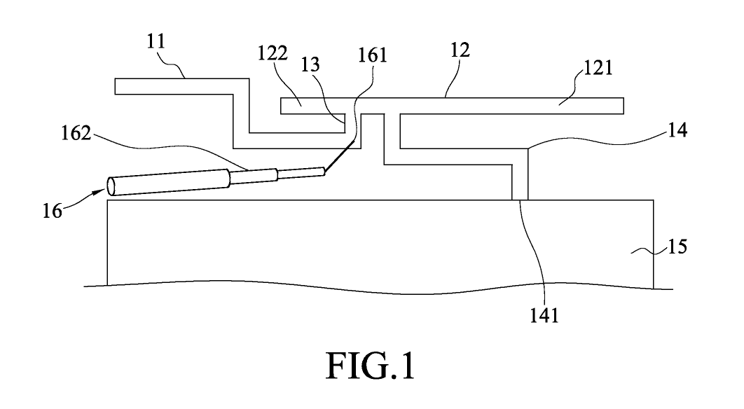

Refer to FIG. 1 a top view of a multi-frequency antenna according to a first embodiment of the present invention. The multi-frequency antenna of the present invention comprises a first conductor 11, a second conductor 12, a feeder conductor 13, a short-circuit member 14, a grounding plane 15 and a feeder cable 16.

The first conductor 11 has a serpentine form. The second conductor 12 is parallel to the first conductor 11 and extends in one side of the first conductor 11. The feeder conductor 13 connects the first conductor 11 and the second conductor 12. The short-circuit member 14 connects with the second conductor 12 and extends serpentinely with an end 141 thereof connecting with the grounding plane 15. The short-circuit member 14 is arranged in one side of the second conductor 12 and connects with the second conductor 12 at a near-central point of the second conductor 12, which divides the second conductor 12 into a first extension 121 and a second extension 122. The feeder cable 15 includes a central wire 161 and an external wire 162. The central wire 161 connects with the feeder conductor 13, and the external wire 162 connects with the grounding plane 15. The position where the central wire 161 connects with the feeder conductor 13 neighbors the junction of the feeder conductor 13 and the first conductor 11.

In the first embodiment, the feeder conductor 13, the second conductor 12 and the short-circuit member 14 form a dual-band antenna structure. The short-circuit member 14 connects with the second conductor 12 at a near-central point of the second conductor 12, which divides the second conductor 12 into the first extension 121 and the second extension 122, whereby are generated a high-frequency resonant mode and a low-frequency resonant mode. The feeder conductor 13, the first conductor 11 and the short-circuit member 14 form a single-band loop antenna. The path length from the end 141 of the short-circuit member 14 to the point where the central wire 161 connects with the feeder conductor 13 is about equal to one fourth of the wavelength of the signal having the central frequency of the first resonant mode. The total length of the first conductor 11 is equal to the path length, whereby the first conductor 11 can generate a second resonant mode. The junction of the short-circuit member 14 of the first conductor 11 and the second conductor 12 is regarded as in an open-loop state lest the two antenna modules interfere mutually. Thereby, the two antenna modules are integrated in an identical radiation conductor structure. In the first embodiment, the first conductor 11 has a Z-like shape, which may be divided into three rectangles. The rectangle connecting with the feeder conductor 13 has a length of about 20 mm and a width of about 2 mm. The second rectangle has a length of about 6 mm and a width of about 2 mm. The third rectangle has a length of about 22 mm and a width of about 2 mm. The second conductor 12 has a rectangular shape with a length of 56 mm and a width of about 2 mm. The feeder conductor 13 has a rectangular shape with a length of about 5 mm and a width of about 2 mm. The short-circuit member 14 has a Z-like shape, which may be divided into three rectangles. The rectangle connecting with the second conductor 12 has a length of about 8 mm and a width of about 2 mm. The second rectangle has a length of 22 mm and a width of about 2 mm. The third rectangle connecting with the grounding plane 15 has a length of about 9 mm and a width of about 2 mm.

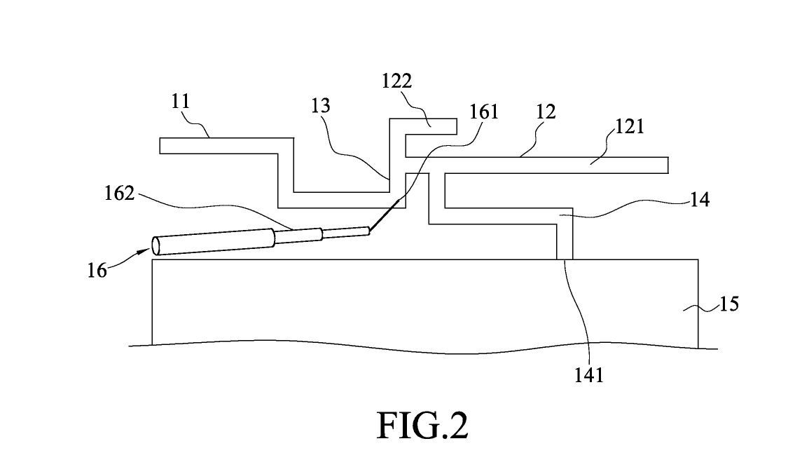

Refer to FIG. 2 a top view of a multi-frequency antenna according to a second embodiment of the present invention. The second embodiment is basically similar to the first embodiment but different from the first embodiment in that the second extension 122, which is separated from the first extension 121 by the position where the short-circuit member 14 connects with the second conductor 12, is in a crooked form. In the second embodiment, the second extension 122 is still parallel to the first extension 121 of the second conductor 12 and an extension of the first conductor 11. Therefore, the conductor design of the present invention not only can form diversified serpentine extensions of the conductors but also can increase the operating bandwidth and suitable frequency bands.

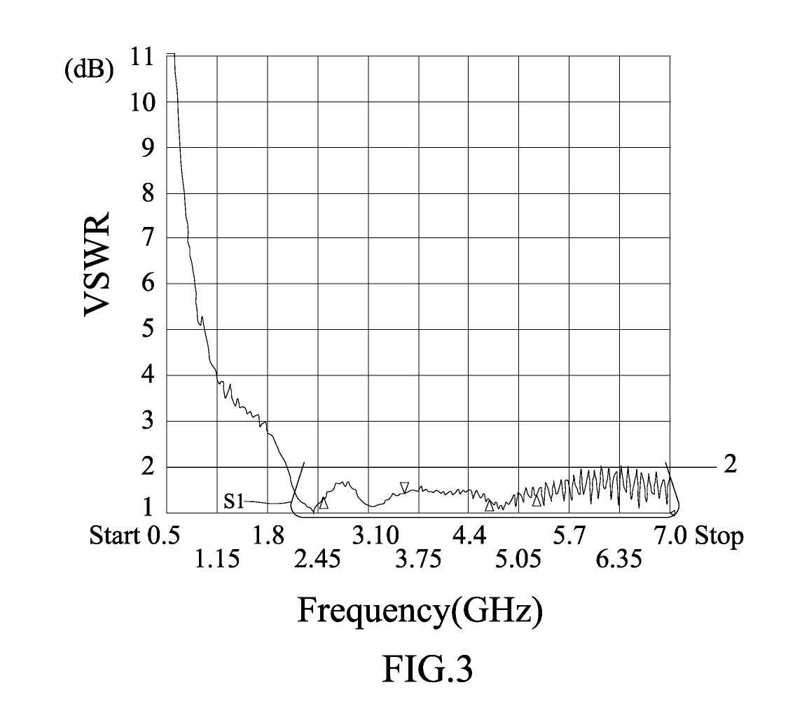

Refer to FIG. 3 a diagram showing the measurement results of the voltage standing wave ratio (VSWR) of the multi-frequency antenna according to the second embodiment of the present invention, wherein the horizontal axis represents frequency and the vertical axis represents dB. FIG. 3 shows that the operational frequency band S1 ranges from 2.0 to 7.0 GHz, which covers the frequency bands of the WLAN 802.11b/g system (ranging from 2.4 to 2.5 GHz), the WiMAX 2.3 G system (ranging from 2.5 to 2.7 GHz), the WiMAX 3.5 G system (ranging from 3.3 to 3.8 GHz), and the WiMAX system (ranging from 4.9 to 2.825 GHz).

In the standards, an antenna is required to have VSWR lower than 3. Otherwise, the antenna would not have the required performance. FIG. 3 shows that VSWR is lower than 3 in all the frequency bands and lower than 2 in most of the frequency bands. Thus, the operating bandwidth is greatly increased. Therefore, FIG. 3 proves that the operating bandwidths of the present invention can satisfy the design requirement.

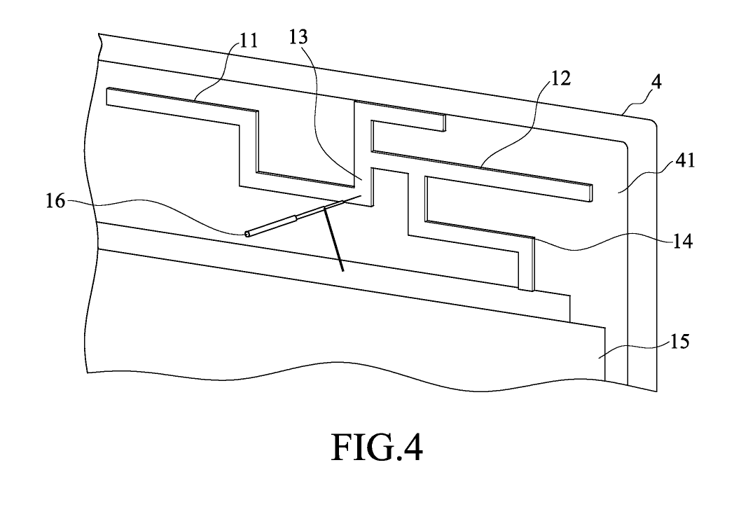

Refer to FIG. 4 a partially-enlarged perspective view schematically showing that the multi-frequency antenna of the second embodiment is applied to a portable computer. The antenna module of the present invention is fixed to the display frame of a portable computer 4 to transceive wireless signals. In the present invention, the diversified serpentine extensions of conductors not only reduce the antenna volume but also favor the arrangement of the components.

The present invention possesses utility, novelty and non-obviousness and meets the condition for a patent. Thus, the Inventors file the application. It is appreciated if the patent is approved fast.

The embodiments described above are only to exemplify the present invention but not to limit the scope of the present invention. Any equivalent modification or variation according to the spirit of the present invention is to be also included within the scope of the present invention.

What is claimed is:

1. A multi-frequency antenna comprising
a first conductor having a serpentine form;
a second conductor parallel to said first conductor and extending in one side of said first conductor;
a feeder conductor connecting said first conductor and said second conductor;
a short-circuit member arranged in one side of said second conductor, and extending serpentinely, wherein said short-circuit member connects with said second conductor at a near-central position of said second conductor, which divides said second conductor into a first extension and a second extension;
a grounding plane connecting with one end of said short-circuit member; and
a feeder cable including
a central wire connecting with said feeder conductor; and
an external wire connecting with said grounding plane.

2. The multi-frequency antenna according to claim 1, wherein a position where said central wire of said feeder cable connects with said feeder conductor neighbors a junction of said feeder conductor and said first conductor.

3. The multi-frequency antenna according to claim 1, wherein said first conductor has a length able to excite a first resonant mode.

4. The multi-frequency antenna according to claim 3, wherein a path length from said end of said short-circuit member to said point where said central wire connects with said feeder conductor is about equal to one fourth of a wavelength of a signal having a central frequency of said first resonant mode.

5. The multi-frequency antenna according to claim 1, wherein a path length from said end of said short-circuit member to said point where said central wire connects with said feeder conductor is about equal to an overall length of said first conductor.

6. The multi-frequency antenna according to claim 1, wherein a better impedance matching of a system bandwidth can be achieved via fine-tuning length, size and volume of said short-circuit member.

7. The multi-frequency antenna according to claim 1, wherein a better impedance matching of a system bandwidth can be achieved via fine-tuning length, shape and size of a serpentine path of said first conductor.
